(19) United States
(12) Patent Application Publication
(10) Pub. No.: US 2004/0036350 A1
(43) Pub. Date: Feb. 26, 2004

(54) Antitheft braking system for trucks, trailers and motor vehicles

(76) Inventors: Steven D. Rowe, Urbandale, IA (US); Gene E. Johnson, Des Moines, IA (US)

Correspondence Address: STURM & FIX LLP, 206 SIXTH AVENUE, SUITE 1213, DES MOINES, IA, 50309-4076, US

(21) Appl. No.: 10/226,827

(22) Filed: Aug. 23, 2002

(51) Int. Cl. B60T 17/16

(52) U.S. Cl. 303/89

(57) ABSTRACT

Wheeled vehicles such as semi trailers, trucks, and automobiles are typically outfitted with a braking system. This braking system can effectively be used to discourage or prevent theft of the wheeled vehicle. A method and apparatus utilizing a valve is inserted in a brake line to disallow pressure information to pass to the brakes from the source of pressure. For air brakes, the valve can be used to block the flow of air from the air compressor to the brakes; or it can be used to vent the air to the atmosphere. For vehicles with hydraulic brakes, an actuated check valve which (when actuated) permits the flow of brake fluid to the brakes but will not permit the relief of pressure in the slave cylinders is used. In either case (pneumatic or hydraulic brakes), the command for actuating the valve can be received from a remote device such as a keypad in the cab of the vehicle or elsewhere, a key-fob transmitter, a cell phone, a radio frequency device, or a web-based communications device.

### BACKGROUND OF THE INVENTION

1. Field of the Invention

The present invention relates generally to a method and apparatus for disallowing the disengaging of the brakes on semi trailers, straight trucks and other motor vehicles. More particularly to system including a valve that is placed in the pneumatic or hydraulic brake line of the vehicle or trailer that either blocks the flow of the working fluid or, in the case of air brakes, may vent the air for disengaging the brakes to the atmosphere. The command to actuate the valve may be communicated locally or remotely. If theft is attempted, the brakes on the vehicle or trailer will not disengage, making the vehicle or trailer effectively immobile.

2. Background Art

A semi trailer with its contents, disengaged from the tractor can become a target for theft. All that is needed is a tractor with sufficient power to pull the trailer. Hooking onto a trailer is a brief procedure and there is little on the trailer to identify it as not belonging to the tractor pulling it. Security for the contents of a semi trailer has consisted of locks on the doors and alarm systems that alarm upon tampering. Because the energy required for releasing the brakes comes from the tractor, security for the trailer, itself (with contents), has been provided by other devices, exclusive of the brakes. Rowe Electronics has developed a proprietary device that is located in the wheel end and is unaffected by removal of external brake components. This device represents an additional system, independent of the braking system. Yet, every semi trailer has a braking system. This braking system could be used to prevent theft with minor, inexpensive modifications.

For vehicles having hydraulic brakes, simple valves are available on the market to lock the brakes by pressurizing the braking system (applying a force to the brake pedal) and closing the valve. These valves are sold as a device for emergency braking and restricted off-road use, only. They require that the operator be in the vehicle when the brake is set, and cannot be activated remotely.

There is, therefore, a need for a simple, effective, inexpensive antitheft system for wheeled vehicles such as semi tractors, which can also be used on any motor vehicle utilizing air brakes; and for vehicles such as automobiles with hydraulic brakes. Such a system should utilize existing brakes to reduce the complexity of the system and to keep the cost down.

### SUMMARY OF THE INVENTION

A purpose of this invention is to provide a method and device for eliminating or discouraging the theft of vehicles such as semi trailers, semi tractors and trucks having air brakes. This method utilizes the standard braking mechanism already installed on these vehicles.

The air brakes on trucks and semi trailers are fail-on, that is, they require air pressure to disengage them. If the air pressure is not permitted to build up in the braking system, the brakes will not disengage. To lock these brakes on, the pressure from the pneumatic system must be disallowed to build up in the brakes to the point they disengage.

An additional purpose of the present invention is to provide a method and device for eliminating or discouraging the theft of vehicles having hydraulic brakes. This method and device utilizes the standard braking mechanism already installed on these vehicles.

Pressure to engage hydraulic brakes comes from a master cylinder, controlled by a force on the brake pedal, often boosted by engine power. To lock the brakes on, requires that hydraulic fluid be permitted to pass into the slave cylinders within the brake assemblies at each wheel, while being disallowed to pass out of the same.

To accomplish these purposes, a valve is inserted into the brake lines (pneumatic or hydraulic), preventing the forces that engage the brake mechanisms from being relaxed.

In the case of air (or pneumatic) brakes, there are two ways to disallow the pressure (required to disengage the brakes) to build up in the braking system:

1. A valve can be placed in the pneumatic line between the air supply (compressor) and the brakes that, when actuated, closes and effectively blocks air from passing through the valve to the brakes.

2. A valve can be placed in the pneumatic line between the air supply (compressor) and the brakes that, when actuated, is opened and vents the air from the tractor to the atmosphere at a sufficient rate to keep the pressure in the brakes too low to disengage the brakes.

3. A valve may also be placed in the tractor or trailer air supply line to vent pressure from the brake side of the valve, also blocking air flow from the supply side of the valve.

With either of these methods, the valves can be disengaged such that the brakes can be operated normally.

In the case of hydraulic brakes, an actuated check valve is inserted into the hydraulic brake line between the master cylinder and the slave cylinders. This check valve will permit the flow of hydraulic fluid into the slave cylinders, engaging the brakes, but will disallow the hydraulic fluid from flowing back out of the slave cylinders. The check valve can be opened to permit the normal use of the brakes.

Another aspect of this invention is that of effecting the engagement of any of these valves. To prevent theft, the engagement mechanism or apparatus must be secure from would-be thieves. One natural approach for this engagement is to house the valve in a lockable container or have the ability to secure and lock the valve stem in position. Another approach is to actuate the valve with an electromagnetic actuator, activated by a keypad with password protection, or activated by a remote device such as a key fob transmitter (such as those used to lock automobile doors), cell phone, radio frequency transmission, or web-based communication device.

### BRIEF DESCRIPTION OF THE DRAWINGS

FIG. 1 shows a semi and communication device antenna with the present invention installed.

FIG. 2 shows a straight truck with the present invention installed.

FIG. 3 shows an automobile with the present invention installed.

FIG. 4 shows a schematic of a valve for blocking the flow of air in pneumatic brakes.

FIG. 5 shows a schematic of a valve for venting air from pneumatic brakes to the atmosphere.

FIG. 6 shows a schematic of an antitheft device including a speed sensor.

FIG. 7 shows a schematic of a check valve in a hydraulic brake system.

### BEST MODE FOR CARRYING OUT THE INVENTION

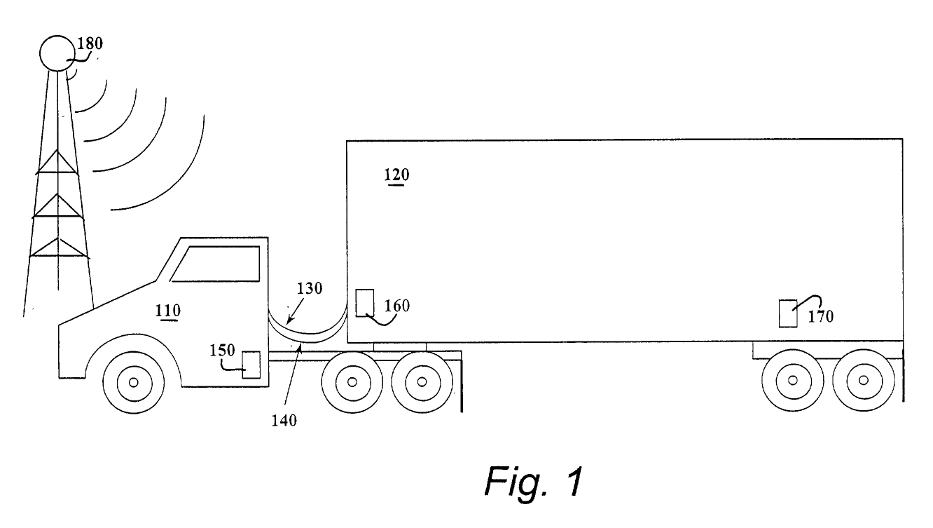

A schematic depiction of a semi tractor 110 and connected semi trailer 120 is shown in FIG. 1. A set of trailer service air lines 130 run between the tractor 110 and trailer 120.

Along with the air lines 130, a communications data cable 140 connects the power unit module 150 and the valve module 160 (an alternate location for the valve module is 10 shown as 170).

A signal to activate the antitheft unit emanates from a source 180 such as antenna 180 as shown in FIG. 1. The signal source 180 could be a keypad located on the truck or a remote device such as a key fob transmitter, cell phone, radio frequency transmission, or web-based communication device. The signal is picked up by power unit module 150 as a command to put the antitheft device into its secure mode. A second signal is generated by power unit module 150, which is transmitted by data cable 140 to the valve module 160. As a response to the signal, valve module 160 energizes its antitheft device. Air brakes are engaged by default, so when the antitheft device is engaged, the brakes cannot be disengaged by coupling with a source of compressed air. At this time, the tractor can be uncoupled from the trailer, and the trailer remains secure.

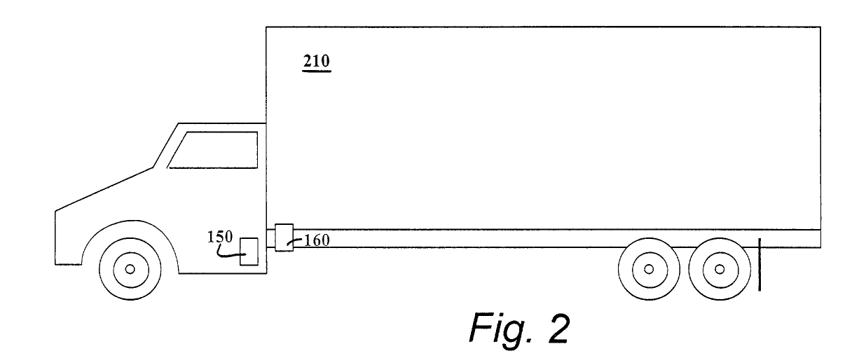

In the case of a straight truck, cement truck, bus or any vehicle having air brakes, the present invention is effected similarly. FIG. 2 shows a straight truck 210, but this application of the present invention is not limited to a straight truck. Here too, a power unit module 150 and a valve module 160 are used. In this case, these two units could be physically adjacent to one another because the cab is never uncoupled with its load. A communications line must exist in this application as well, but is not shown in FIG. 2. This data line can be permanently installed in the truck, bus, etc. The arrangement shown in FIG. 2 is also useful to secure a semi tractor, itself, irrespective of the trailer. The vehicle is secured in exactly the same manner as described, above, for the semi.

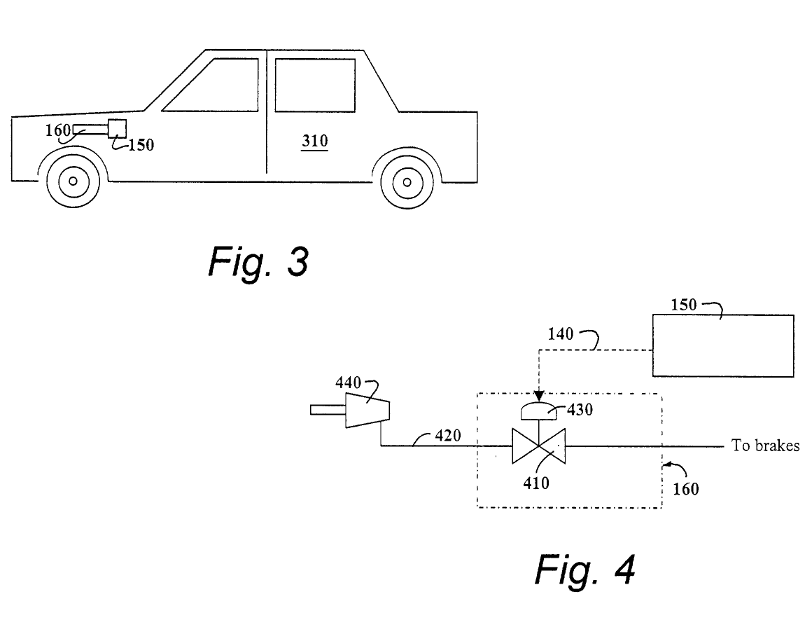

When a vehicle has hydraulic brakes, a similar system can be used to secure it. In FIG. 3 is depicted an automobile 310. Again, this application of this invention is not limited to automobiles, but will work for any vehicle having hydraulic brakes. Such vehicles comprise trucks, buses, pickup trucks, and automobiles. As with a straight truck, the power unit module 150 and the valve module 160 can be placed adjacent to one another as shown in FIG. 3. Communications are made through a permanently installed data line (not shown).

One embodiment of the present invention is shown in FIG. 4, which shows details of valve module 160. This embodiment is useful for vehicles with air brakes. In this embodiment, a valve 410 is inserted into pneumatic line 420 carrying air from the source 440 of compressed air to the brakes. The valve is actuated by electromagnetic actuator 430. Said actuator 430 receives instruction from power unit module 150 via data line 140. When power unit module 150 sends an engage signal, actuator 430 is energized and valve 410 closes, disallowing air to travel to the brakes to disengage them.

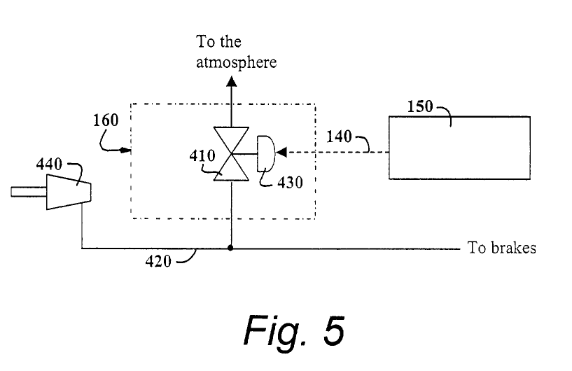

In a second embodiment, shown in FIG. 5, of this invention, valve 410 within valve module 160 is used to vent air from the pneumatic line 420 running from a source 440 of compressed air to the brakes. Valve 410 is sized to pass all the air pumped toward the brakes from the semi tractor (the source of the compressed air) such that the pressure in the brakes will never exceed that required to disengage them. When power unit module 150 sends an engage signal, actuator 430 is energized and valve 410 opens, venting the brake air to the atmosphere and disallowing the pressure in the brakes to increase sufficiently to disengage them. Note that this embodiment can be used to thwart the theft of a semi tractor as well as the trailer because the pressure throughout the entire braking system is affected by venting the air to atmosphere. As in the first embodiment, actuator 430 receives instruction from power unit module 150 via data line 140.

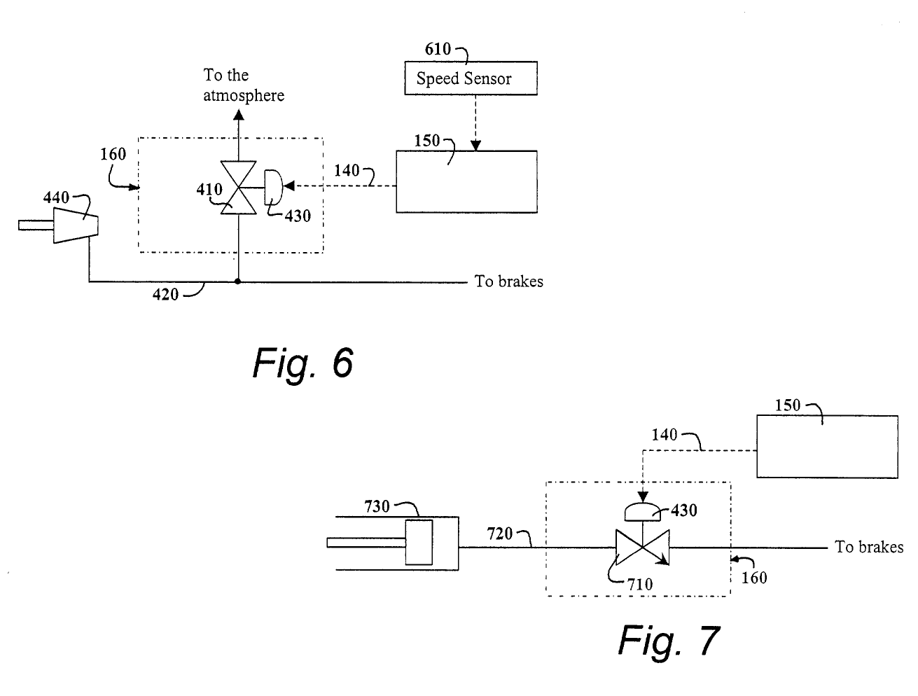

The second embodiment can be applied in cases where a semi trailer must be moved at low speeds, such as in a warehouse setting. A speed sensor 610 is installed on the trailer and interfaced with the power module 150 as shown in FIG. 6. If the speed of the trailer exceeds a pre-selected value, the antitheft system will effect a stratagem to secure the trailer. One approach is to simply set the brakes. Another approach is to continue to monitor speed after the pre-selected speed has been exceeded, and engage the brakes when the speed has dropped below a second pre-selected speed.

In a third embodiment useful for vehicles having hydraulic brakes, is shown in FIG. 7. In this embodiment, the valve 710 installed in the hydraulic line 720 must be an actuated check valve, allowing fluid flow only in one direction when engaged. When disengaged, there is little resistance to flow in either direction. The check valve 710 is installed such that, when engaged by actuator 430, hydraulic fluid is able to flow from the master cylinder 730 toward the brakes, but not in the reverse direction. If a vehicle 310 with an engaged check valve 710 is breached, it may be driven normally until the brakes are applied. When this occurs, hydraulic fluid will pass through check valve 710 to the brakes, but will not return, leaving the brakes engaged. In this condition, the vehicle becomes difficult or impossible to drive due to the extra engine power required to overcome the friction from the brakes. Also, the brakes will become hot. As in the first and second embodiments, actuator 430 receives instruction from power unit module 150 via data line (not shown in FIG. 7).

Obviously many modifications and variations of the present invention are possible in light of the above teachings. It is, therefore, to be understood that within the scope of the appended claims, the invention may be practiced otherwise than as specifically described. For example, the term “wheeled vehicles” is intended to also cover track vehicles, because the tracks of these vehicles are turned by wheels or wheel like members such as pulleys or sprockets.

We claim:

1. A method for preventing theft of a vehicle having an antitheft system comprising an air braking system including a source of air pressure and brakes, said braking system manipulated by pressurizing air; and a valve placed in a line carrying said air between the source of air pressure and the brakes; said method including actuating the valve to disallow air pressure from reaching the brakes.

2. The method of claim 1 wherein the source of fluid pressure is an air compressor.

3. The method of claim 1 wherein actuating the valve closes the valve.

4. The method of claim 1 wherein the valve is situated to vent the working fluid air to atmosphere when the valve is actuated.

5. The method of claim 1 wherein a command to actuate the valve is communicated from a remote device.

6. The method of claim 5 wherein the remote device is a keypad located on the vehicle.

7. The method of claim 5 wherein the remote device is a key fob transmitter.

8. The method of claim 5 wherein the remote device is a cell phone.

9. The method of claim 5 wherein the remote device is a radio frequency device.

10. The method of claim 5 wherein the remote device is a web-based communication device.

11. The method of claim 1 wherein the antitheft device includes a speed sensor, the method comprising the additional steps:
(a) sensing the speed of the wheeled vehicle and comparing said speed to a pre-selected maximum speed; and
(b) actuating the valve if the speed of the vehicle exceeds the pre-selected maximum speed.

12. The method of claim 1 wherein the antitheft device includes a speed sensor, the method comprising the additional steps:
(a) sensing the speed of the wheeled vehicle and comparing said speed to a pre-selected maximum speed;
(b) setting a logic value to true if the speed of the vehicle exceeds the pre-selected maximum speed; and
(c) actuating the valve to engage the brakes if the logic value is true and the speed of the wheeled vehicle drops below a pre-selected minimum speed.

13. A method for preventing theft of a vehicle having an antitheft system comprising a hydraulic braking system including a source of fluid pressure and brakes, said braking system manipulated by pressurizing a hydraulic brake fluid, and a check valve placed in a line carrying said fluid between the source of pressure and the brakes; said method including activating the check valve to disallow relieving pressure from the brakes.

14. The method of claim 13 wherein the source of fluid pressure is a master cylinder.

15. The method of claim 13 wherein the check valve is an actuated check valve which, when activated, permits the flow of hydraulic brake fluid toward the brakes but disallows the flow of hydraulic brake fluid away from the brakes.

16. The method of claim 13 wherein a command to actuate the valve is communicated from a remote device.

17. The method of claim 16 wherein the remote device is a keypad located on the vehicle.

18. The method of claim 16 wherein the remote device is a key fob transmitter.

19. The method of claim 16 wherein the remote device is a cell phone.

20. The method of claim 16 wherein the remote device is a radio frequency device.

21. The method of claim 16 wherein the remote device is a web-based communication device.

22. An antitheft apparatus for preventing theft of a vehicle with a braking system comprising a source of air pressure and brakes, said braking system manipulated by pressurizing air; the antitheft apparatus comprising a valve means placed in a line carrying said air between the source of air pressure and the brakes and means for actuating the valve to disallow air pressure from reaching the brakes.

23. The apparatus of claim 22 wherein means for actuating the valve means includes means for closing the valve.

24. The apparatus of claim 22 wherein the means for actuating the valve means effects a venting of the working fluid air to atmosphere.

25. The apparatus of claim 22 including a remote communication means to communicate a command to actuate the valve.

26. The apparatus of claim 25 wherein the remote communication means is a keypad located on the vehicle.

27. The apparatus of claim 25 wherein the remote communication means is a key fob transmitter.

28. The apparatus of claim 25 wherein the remote communication means is a cell phone.

29. The apparatus of claim 25 wherein the remote communication means is a radio frequency communication means.

30. The apparatus of claim 25 wherein the remote device is a web-based communication means.

31. The apparatus of claim 22 wherein the antitheft device includes means to sense a speed of the vehicle, the apparatus comprising the additional means:
(a) means for comparing said speed to a pre-selected maximum speed; and
(b) means for actuating the valve means if the speed of the vehicle exceeds the pre-selected maximum speed.

32. The apparatus of claim 22 wherein the antitheft device includes means to sense a speed of the wheeled vehicle, the apparatus comprising the additional means:
(a) means for comparing said speed to a pre-selected maximum speed;
(b) means for setting a logic value to true if the speed of the vehicle exceeds the pre-selected maximum speed; and
(c) means for actuating the valve means to engage the brakes if the logic value is true and the speed of the vehicle drops below a pre-selected minimum speed.

33. An antitheft apparatus for preventing theft of a vehicle with a braking system comprising a source of fluid pressure and brakes, said braking system engaged by pressurizing hydraulic brake fluid; the antitheft apparatus comprising a check valve placed in a line carrying said fluid between the source of pressure and the brakes and means for activating the check valve to disallow relieving pressure from the brakes.

34. The apparatus of claim 33 wherein the check valve is an actuated check valve which, when actuated, permits the flow of hydraulic brake fluid toward the brakes but disallows the flow of hydraulic brake fluid away from the brakes.

35. The apparatus of claim 33 including a remote communication means to communicate a command to actuate the valve.

36. The apparatus of claim 35 wherein the remote communication means is a keypad located on the vehicle.

37. The apparatus of claim 35 wherein the remote communication means is a key fob transmitter.

38. The apparatus of claim 35 wherein the remote communication means is a cell phone.

39. The apparatus of claim 35 wherein the remote communication means is a radio frequency communication means.

40. The apparatus of claim 35 wherein the remote communication means is a web-based communication means.
